(19) United States
(12) Patent Application Publication
(10) Pub. No.: US 2005/0212984 A1
(43) Pub. Date: Sep. 29, 2005

(54) Dual-mode display system for 2D and 3D viewing

(76) Inventors: Yi-Chun Wu, Hualien City (TW); Wen-Jui Liao, Taiping City (TW)

Correspondence Address: BIRCH STEWART KOLASCH & BIRCH, PO BOX 747, FALLS CHURCH, VA, 22040-0747, US

(21) Appl. No.: 10/809,375

(22) Filed: Mar. 26, 2004

(51) Int. Cl. C09K 19/00

(52) U.S. Cl. 349/15; 349/84

(57) ABSTRACT

The present invention provides a parallax barrier which can be converted to the transmissive type if necessary, thereby converting 2D viewing to 3D viewing. The parallax barrier of the present invention is constituted by a twist nematic shutter, a polarizer is disposed on the outside surface of a substrate of the parallax barrier, and the substrate can be replaced with a plastic film, whereby the object distance between the view position of the parallax barrier and the display pixel of a display device is a shorter distance so as to provide a 3D image with a shorter view distance.

### FIELD OF THE INVENTION

The present invention relates to a dual-mode display system for 2D and 3D viewing, and more particularly to a dual-mode display system for 2D and 3D viewing having parallax barrier for converting from 2D to 3D viewing and vice versa.

### BACKGROUND OF THE INVENTION

Referring to FIG. 1, U.S. Pat. No. 6,108,029 entitled “Dual-mode 2D/3D display system” discloses that a backlight 1 and a parallax barrier 2 are disposed either side of a displace device 3 (a transmissive type panel). The parallax barrier 2 has dual mode: a transmissive type and a barrier type. A switch 12 controls the parallax barrier 2 that converts transmissive and barrier types between each other if necessary; therefore performing bi-directional conversions between 2-dimensional (mentioned as 2D hereafter) and 3-dimensional (mentioned as 3D hereafter) displays.

FIG. 2 depicts a display system, which includes a liquid crystal display 4 having a backlight 7, and a parallax barrier 2 for converting between 2D viewing and 3D viewing. The parallax barrier 2 is a twist nematic shutter and is consists of a polarizer 5, a substrate 6, a liquid crystal layer 8, a substrate 6 and a polarizer 5. The function of the polarizer 5 which is disposed on the inside of the parallax barrier 2 can be replaced With the function of a polarizer 5 which is disposed on the outside of the liquid crystal display 4, and therefore the polarizer 5 which is disposed on the inside of the parallax can be removed. In this constitution, a view position 9 of the parallax barrier 2 is the position of the polarizer 5 which is disposed on the outside of the parallax barrier 2, a display pixel 10 of the liquid crystal display 4 is disposed at the position of the polarizer 5 which is disposed on the front side of the liquid crystal display 4, the distance between the view position 9 of the parallax barrier 2 and the display pixel 10 is denoted by letter d, The spacing between opaque and clear linear sections adjacent pixel columns on the parallax barrier 2 is denoted by letter Δp, the spacing between the right view and left view of the display pixel 10 is denoted by letter ΔL, the distance between the right eye and left eye of a viewer 11 is denoted by S, the distance between the viewer 11 and the view position 9 of the parallax barrier 2 is denoted by letter D, and the spacing Δp is about two times of the spacing ΔL, wherein an equation is
d=ΔL(D+d)/S
, where Δp, ΔL and S are limited by the viewer 11 and the necessary resolution of the liquid crystal display 4 are generally constant. Here Δp is equal to 0.016 centimeter, ΔL is equal to 0.008 centimeter, and S is equal to 6.5 centimeters. According to the abovementioned equation, the distance d is positive and proportional to the distance D. The distance D, i.e., the minimum distance of forming a 3-D image after computing, is 60 centimeters. It is apparent that the distance D being 60 centimeters is not useful for applying to display systems with medium/small dimensions.

FIG. 3 illustrates an embodiment of U.S. Pat. No. 5,969,850 entitled “Spatial light modulator, directional display and directional light source”. As compared with the above-mentioned display system, the U.S. Pat. No. 5,969,850 discloses that one substrate 6 of liquid crystal display 4 is removed to decrease the distance d and in turn decrease the distance D being equal to 35 centimeters. Although the distance D being 35 centimeters meet the applied requirement of the display system with medium/small dimension, two sides of the substrate 6 must be both processed by using coating, etching, rubbing, etc. It is apparent that the substrate 6 having two sides which are both processed is very different from the current substrate 6 in the prior art having only one side which is processed is by using coating, etching, rubbing, etc. The cost of mass production is high, and therefore apparent that the substrate 6 having two sides, which are both processed, cannot meet the requirements of mass production.

Accordingly, there exists a need for a dual-mode display system for 2D and 3D viewing to solve the above-mentioned problems and disadvantages.

### SUMMARY OF THE INVENTION

It is an objective of the present invention to provide a dual-mode display system for 2D and 3D viewing having a manufacturing process of a parallax barrier for decreasing the distance between the view position of a parallax barrier and a display pixel of a display device.

In order to achieve the foregoing objects, the present invention provides a dual-mode display system for 2D and 3D viewing including a display device and a parallax barrier. The parallax barrier has a second polarizer, a second substrate, a liquid crystal layer, a first polarizer and a first substrate, characterized in that the second polarizer, the second substrate, the liquid crystal layer, the first polarizer and the first substrate are disposed on the display device in sequence.

The dual-mode display system, according to the present invention has an object distance between the view position of the parallax barrier and display pixel (being approximately half of the object distance d in the prior art) and the viewing distance between the viewer and view position of the parallax barrier, around 35 centimeters after calculating, to meet the requirements display systems with medium/small dimension. In addition, the present invention utilizes the technology of plastic liquid crystal panel and a substrate is replaced with a plastic substrate for decreasing the object distance and further decreasing the view distance.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural schematic view of a dual-mode display system for 2D and 3D viewing in the prior art.

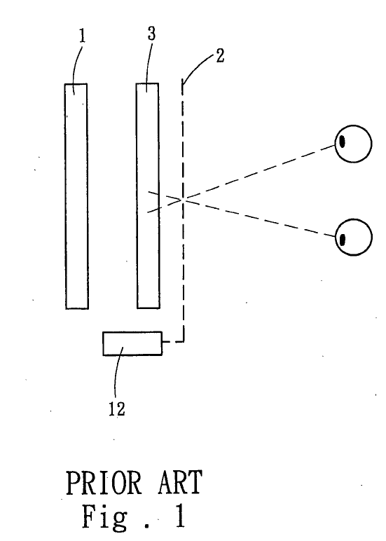

FIG. 2 is a structural sectional schematic view of a dual-mode display system for 2D and 3D viewing in the prior art.

FIG. 3 is a structural sectional schematic view of another dual-mode display system for 2D and 3D viewing in the prior art.

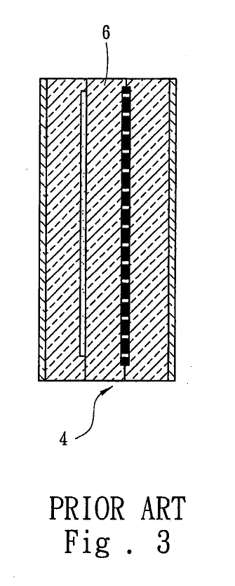

FIG. 4 is a structural sectional schematic view of a dual-mode display system for 2D and 3D viewing according to the first embodiment of the present invention.

FIG. 5 is a manufacturing flow diagram of a dual-mode display system for 2D and 3D viewing according to the first embodiment of the present invention.

FIG. 6 is a structural sectional schematic view of a dual-mode display system for 2D and 3D viewing according to the second embodiment of the present invention.

FIG. 7 is a manufacturing flow diagram of a dual-mode display system for 2D and 3D viewing according to the second embodiment of the present invention.

FIG. 8 is a structural sectional schematic view of a dual-mode display system for 2D and 3D viewing according to the third embodiment of the present invention.

FIG. 9 is a manufacturing flow diagram of a dual-mode display system for 2D and 3D viewing according to the third embodiment of the present invention.

FIG. 10 is a structural sectional schematic view of a dual-mode display system for 2D and 3D viewing according to the fourth embodiment of the present invention.

FIG. 11 is a manufacturing flow diagram of a dual-mode display system for 2D and 3D viewing according to the fourth embodiment of the present invention.

FIG. 12 is a structural sectional schematic view of a dual-mode display system for 2D and 3D viewing according to the fifth embodiment of the present invention.

FIG. 13 is a manufacturing flow diagram of a dual-mode display system for 2D and 3D viewing according to the fifth embodiment of the present invention.

FIG. 14 is a structural sectional schematic view of a dual-mode display system for 2D and 3D viewing according to the sixth embodiment of the present invention.

FIG. 15 is a structural sectional schematic view of a dual-mode display system for 2D and 3D viewing according to the seventh embodiment of the present invention.

FIG. 16 is a structural sectional schematic view of a dual-mode display system for 2D and 3D viewing according to the eighth embodiment of the present invention.

### DESCRIPTION OF THE PREFERRED EMBODIMENTS

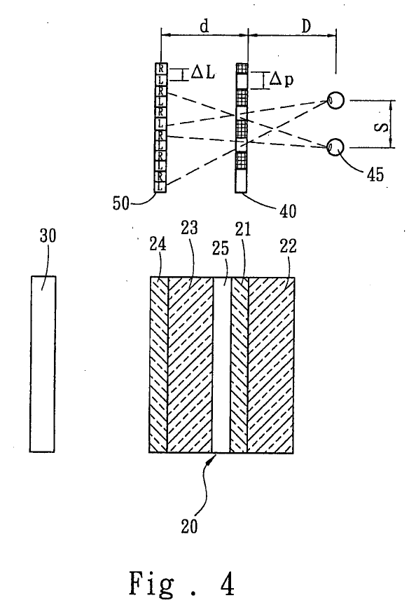

FIG. 4 defines the structure of a dual-mode display system for 2D and 3D viewing according to the first embodiment of the present invention. The dual-mode display system includes a display device 30 and a parallax barrier 20A disposed on the outside surface of the display device 30. The parallax barrier 20A includes a second polarizer 24, a second substrate 23, a liquid crystal layer 25, a first polarizer 21 and a first substrate 22 that are disposed on the display device 30 in sequence. A surface of the first substrate 22 and a surface of the second substrate 23 of which both are close to the liquid crystal layer 25 have a specific pattern of electrodes (not shown). The two surfaces that contact the liquid crystal layer 25 are processed by using rubbing treatment for arranging the crystal molecules of the liquid crystal layer 25 in a specific direction. The parallax barrier 20A changes the arrangement of the crystal molecules in the liquid crystal layer 25 through the electrode of the first substrate 22 and the second substrate 23 by controlling the outside voltage. The parallax barrier 2 has a dual mode: a transmissive type and a barrier type, converting the transmissive type and the barrier type to each other if necessary, and further converting 2D viewing and 3D viewing to each other.

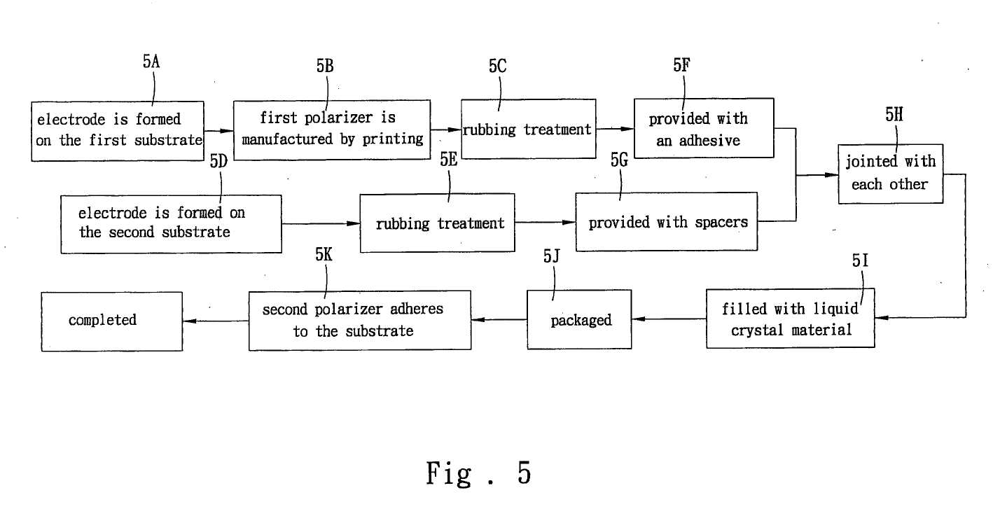

Referring to FIG. 5, it depicts a flow diagram of manufacturing a parallax barrier 20A according to the first embodiment of the present invention. In step 5A, a specific pattern of electrode forms on the surface of the first substrate 22. In step 5B, the first polarizer 21 is manufactured, and the surface of the first substrate 22 can be coated with the first polarizer 21 by means of printing. In step 5C, a surface of the first polarizer 21 is processed by means of a rubbing treatment. In step 5D, a specific pattern of electrodes is formed on the surface of the second substrate 23. In step 5E, the surface of the second substrate 23 is processed by means of rubbing treatment. In step 5F, the first substrate 22 is provided with an adhesive. In step 5G, the second substrate 23 is provided with a plurality of spacers. In step 5H, the first substrate 22 and the second substrate 23 are joined to each other. In step 5I, a space between the first substrate 22 and the second substrate 23 is filled with liquid crystal material. In step 5J, the first substrate 22 and the second substrate 23 are packaged. In step 5K, the second polarizer 24 adheres to a surface of the second substrate 23 to complete the parallax barrier 20A.

Referring to FIG. 4 again, a view position 40 (the actual position of the alternate opaque and clear linear sections viewed by the viewer 45) of the parallax barrier 20A is the position of the first polarizer 21. A display pixel 50 of the display device 30 is located at the position of the second polarizer 24, the distance between the view position 40 of the parallax barrier 20A and the display pixel 50 is denoted by letter d. The spacing between opaque and clear linear sections on the view position 40 is denoted by letter Δp, the spacing between the right view and left view of the display pixel 50 is denoted by letter ΔL, the distance between the right eye and left eye of a viewer 45 is denoted by S, the distance between the viewer 45 and the view position 40 of the parallax barrier 20A is denoted by letter D, and therefore the distance d is approximately half of the distance d in the prior art (because the thickness of the first substrate 22 is not required to be considered). For example, the dual-mode display system is actually measured, the distance d is about 0.4˜0.5 mm, and therefore the distance D is about 35 centimeters after calculating so as to meet the requirements of display systems with medium/small dimensions.

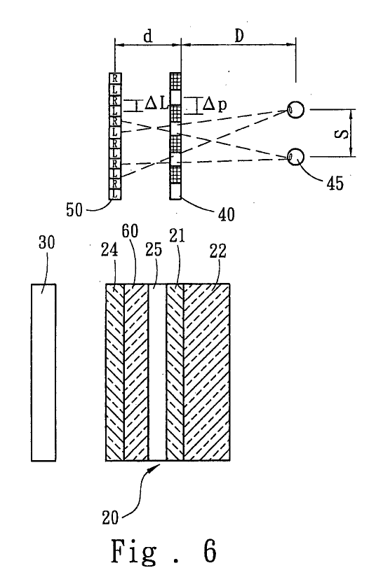

FIG. 6 depicts the structure of a dual-mode display system for 2D and 3D viewing according to the second embodiment of the present invention. The parallax barrier 20B is manufactured by utilizing the technology of plastic liquid crystal panel. As compared with the first embodiment, the second substrate 23 in the second embodiment is replaced with a plastic substrate 60 that is less than 0.2 mm in thickness. The plastic substrate 60 can be made of one of Polyester (PES), Polyethylene Terephthalate (PET) and Artone. The chemical formula of the Artone is as follows:

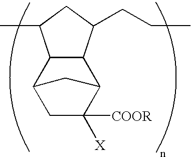

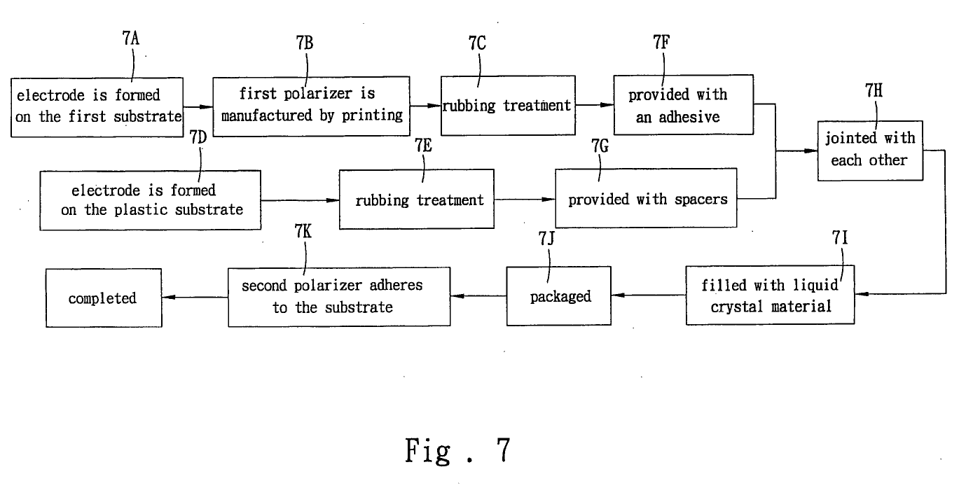

FIG. 7 depicts a flow diagram of manufacturing a parallax barrier 20B according to the second embodiment of the present invention. All Step 7A, Step 7B, Step 7C, Step 7E, Step 7F, Step 7G, Step 7H, Step 7I, Step 7J, Step 7K is same as the steps in the first embodiment except step 7D. The step 7D is similar to the step 5D, wherein the second substrate 23 is replaced with the plastic substrate 60. As described above, the distance d in the second embodiment is much less than the first embodiment, and therefore the distance D is very short after calculating so as to be applied in a specific field.

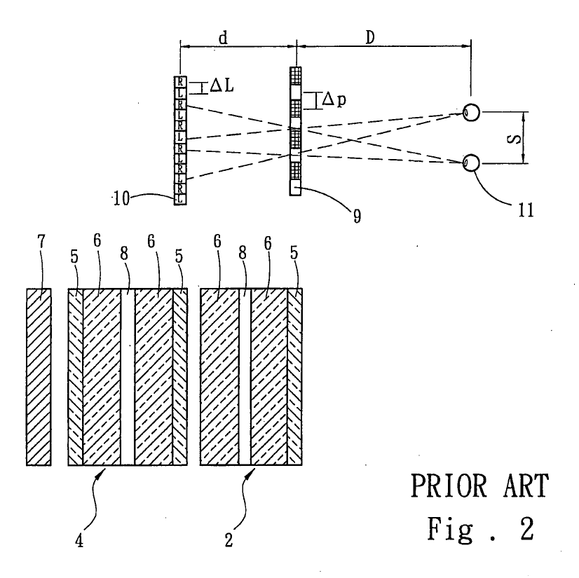

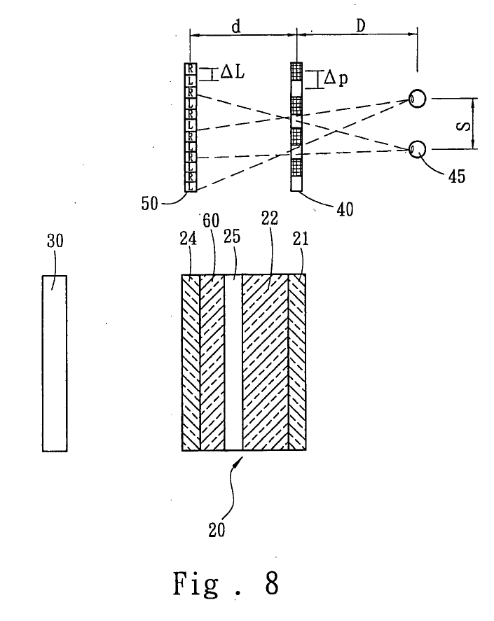

Referring to FIG. 8, it depicts the structure of a dual-mode display system for 2D and 3D viewing according to the third embodiment of the present invention. The parallax barrier 20C is also manufactured by utilizing the technology of plastic liquid crystal panel. As compared with the first embodiment, the first polarizer 21 is removed and disposed on the outside surface of the parallax barrier 20C (similar to the parallax barrier in FIG. 2), and the second substrate 23 is replaced with a plastic substrate 60 which is less than 0.2 mm in thickness. The plastic substrate 60 can be made of one of Polyester (PES), Polyethylene Terephthalate (PET) and Artone.

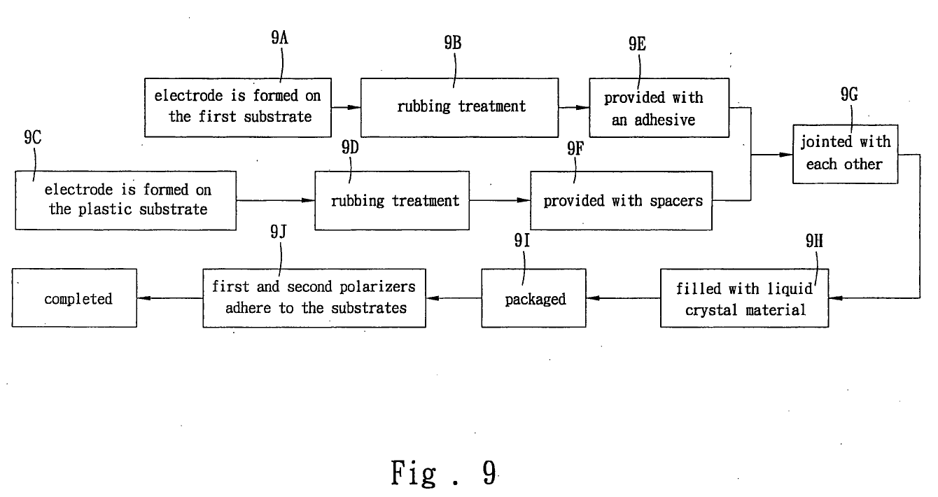

Referring to FIG. 9, it depicts a flow diagram of manufacturing a parallax barrier 20C according to the third embodiment of the present invention. In step 9A and 9C, a specific pattern of electrode is formed on a surface of the first substrate 22 and a specific pattern of electrode is formed on a surface of the plastic substrate 60. In step 9B and 9D, the surface of the first substrate 22 and the surface of the plastic substrate 60 are processed by means of rubbing. In step 9E, the first substrate 22 is provided with an adhesive. In step 9F, the plastic substrate 60 is provided with a plurality of spacers. In step 9G, the first substrate 22 and the plastic substrate 60 are joined together. In step 9H, a space between the first substrate 22 and the plastic substrate 60 is filled with liquid crystal material. In step 9I, the first substrate 22 and the plastic substrate 60 are packaged. In step 9J, the first polarizers 21 adheres to the other surface of the second substrate 23 and the second polarizers 24 adheres to the other surface of the plastic substrate 60 so as to complete the parallax barrier 20C. As described above, the distance d in the third embodiment is much less than that in the prior art, and therefore the distance D is very short after calculating so as to be applied in specific field.

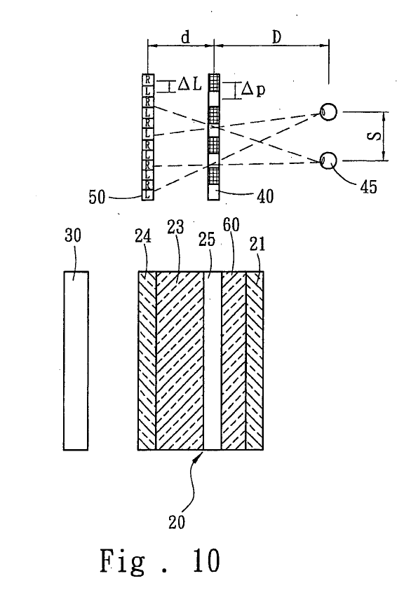

Referring to FIG. 10, it depicts the structure of a dual-mode display system for 2D and 3D viewing according to the fourth embodiment of the present invention. The parallax barrier 20D is also manufactured by utilizing the technology of plastic liquid crystal panel. The dual-mode display system in the fourth embodiment is similar to that of the third embodiment, but the first substrate 22 is replaced with a plastic substrate 60 which is less than 0.2 mm in thickness. The plastic substrate 60 can be made of one of Polyester (PES), Polyethylene Terephthalate (PET) and Artone.

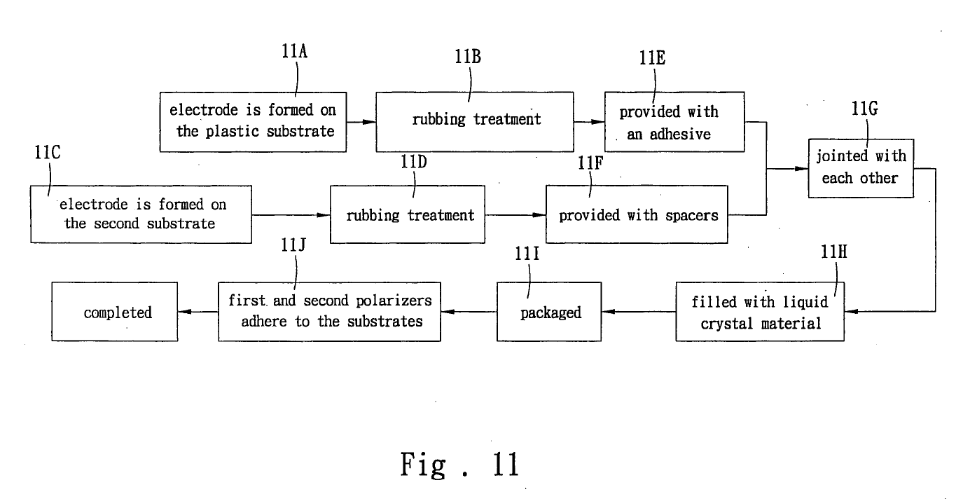

Referring to FIG. 11, it depicts a flow diagram of manufacturing a parallax barrier 20D according to the fourth embodiment of the present invention, wherein the first substrate 22 in the fourth embodiment is replaced with the plastic substrate 60. In step 11C and 11A, a specific pattern of electrode is formed on a surface of the second substrate 23 and a specific pattern of electrode is formed on a surface of the plastic substrate 60. In step 11B and 11D, the surface of the second substrate 23 and the surface of the plastic substrate 60 are processed by means of rubbing treatment. In step 11E, the plastic substrate 60 is provided with an adhesive. In step 11F, the second substrate 23 is provided with a plurality of spacers. In step 11G, the second substrate 23 and the plastic substrate 60 are joined with each other. In step 11H, a space between the second substrate 23 and the plastic substrate 60 is filled with liquid crystal material. In step 11I, the second substrate 23 and the plastic substrate 60 are packaged. In step 11J, the first polarizers 21 adheres to the other surface of the plastic substrate 60 and the second polarizers 24 adheres to the other surface of the second substrate 23 so as to complete the parallax barrier 20D. As described above, the distance d in the fourth embodiment is much less than that in the prior art, and therefore the distance D is very short after calculating so as to be applied in specific field.

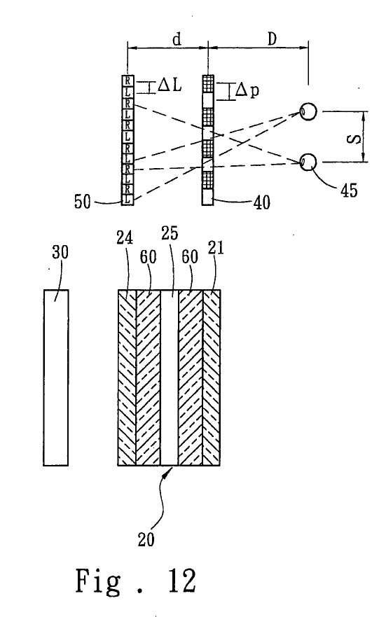

Referring to FIG. 12, it depicts the structure of a dual-mode display system for 2D and 3D viewing according to the fifth embodiment of the present invention. The parallax barrier 20E is also manufactured by utilizing the technology of plastic liquid crystal panel. The dual-mode display system in the fifth embodiment is similar to that in the third embodiment, but the first substrate 22 and the second substrate 23 are replaced with two plastic substrates 60 which are less than 0.2 mm in thickness. The plastic substrate 60 can be made of one of Polyester (PES), Polyethylene Terephthalate (PET) and Artone.

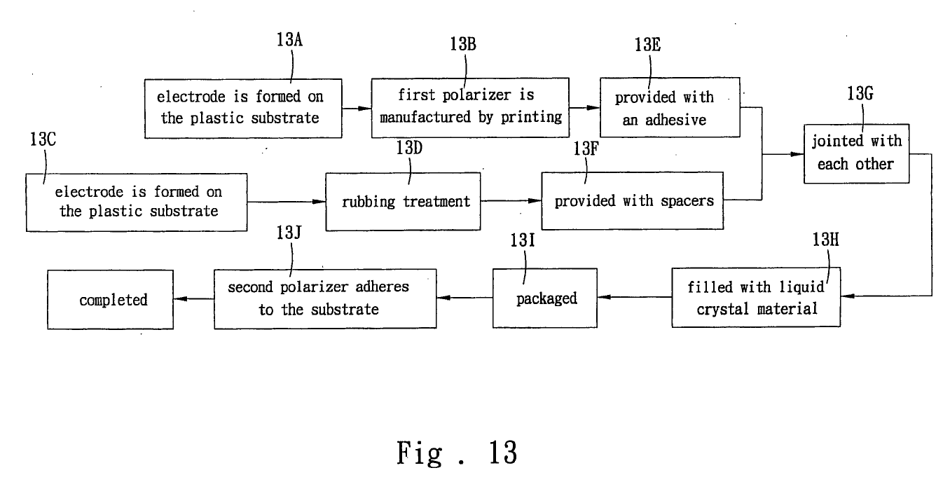

Referring to FIG. 13, it depicts a flow diagram of manufacturing a parallax barrier 20E according to the fifth embodiment of the present invention, wherein the first substrate 22 and the second substrate 23 in the fifth embodiment is replaced with the two plastic substrates 60. In step 13C and 13A, two specific patterns of electrode are respectively formed surfaces of the two plastic substrates 60. In step 13B and 13D, the surfaces of the two plastic substrates 60 are processed by means of rubbing. In step 13E and 13F, the two plastic substrates 60 are provided with an adhesive and a plurality of spacers. In step 13G, the two plastic substrates 60 are joined with each other. In step 13H, a space between the two plastic substrates 60 is filled with liquid crystal material. In step 13I, the two plastic substrates 60 are packaged. In step 13J, the first polarizers 21 and the second polarizers 24 adhere to the other surfaces of the two plastic substrates 60 to complete the parallax barrier 20E. As described above, the distance d in the fifth embodiment is much less than that in the prior art, and therefore the distance D is very short after calculating so as to be applied in specific field.

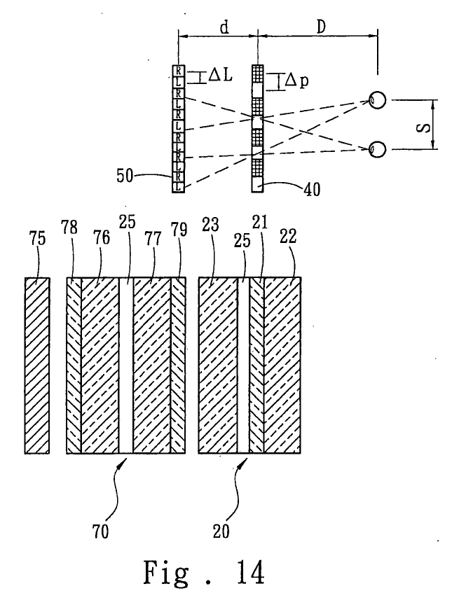

Refer to FIG. 14, for the structure of a dual-mode display system for 2D and 3D viewing according to the sixth embodiment of the present invention. The structure of a parallax barrier 20A of the dual-mode display system in the sixth embodiment is similar to that in the first embodiment, but the display device 30 is replaced with a liquid crystal panel 70 having a backlight module 75. The function of the second polarizer 24 in the first embodiment is replaceable with the function of a fourth polarizer 79 of the liquid crystal panel 70, and therefore the second polarizer 24 can be removed. According to the second, third, fourth and fifth embodiment, the display device 30 is replaced with a liquid crystal panel 70 having a backlight module 75, and the second polarizer 24 can be removed.

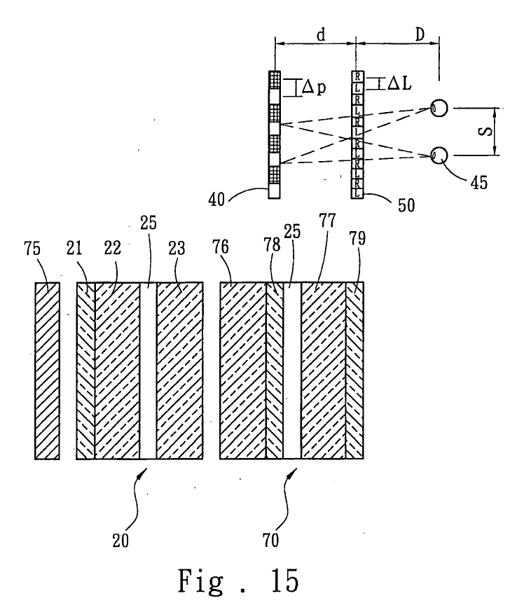

Referring to FIG. 15, it depicts the structure of a dual-mode display system for 2D and 3D viewing according to the seventh embodiment of the present invention. The parallax barrier 20F in the seventh embodiment is similar to the parallax barrier 2 in the prior art (shown in FIG. 2), and is disposed between the liquid crystal panel 70F and the backlight module 75. The liquid crystal panel 70F includes a third substrate 76, a third polarizer 78, a liquid crystal layer 25, a fourth substrate 77 and a fourth polarizer 79 which are disposed on the parallax barrier 20F in sequence. The parallax barrier 20F includes a first polarizer 21, a first substrate 22, a liquid crystal layer 25 and a second substrate 23 which are disposed on the backlight module 75 in sequence. The manufacturing method of the liquid crystal panel 70F is similar to the parallax barrier 20A in the first embodiment, and the third polarizer 78 can form on the surface of the third substrate 76 by means of printing mode. According to the seventh embodiment, a view position 40 (the actual position of the alternate opaque and clear linear sections is viewed by the viewer 45) of the parallax barrier 20F is the position of the third polarizer 78, a display pixel 50 of the liquid crystal panel 70F is located at the position of the fourth polarizer 79. Although the definitions of the distance d and the distance D in the seventh embodiment are not similar to those in the above-mentioned embodiments, the distance D is positive proportional to the distance d. As described above, the distance d in the seventh embodiment is much less than that in the prior art, and therefore the distance D is very short after calculating so as to be applied in specific field.

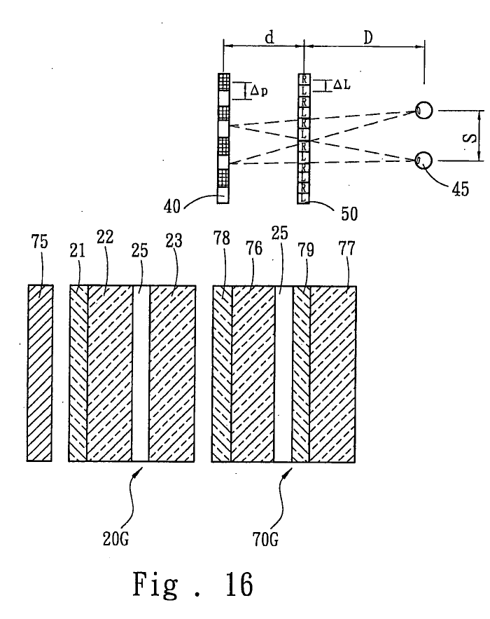

Referring to FIG. 16, it depicts the structure of a dual-mode display system for 2D and 3D viewing according to the eighth embodiment of the present invention. The parallax barrier 20G in the eighth embodiment is similar to the parallax barrier 2 in the prior art (shown in FIG. 2), and disposed between the liquid crystal panel 70G and the backlight module 75. The liquid crystal panel 70G includes a third polarizer 78, a third substrate 76, a liquid crystal layer 25, a fourth polarizer 79 and a fourth substrate 77 which are disposed on the parallax barrier 20G in sequence. The parallax barrier 20G includes a first polarizer 21, a first substrate 22, a liquid crystal layer 25 and a second substrate 23 which are disposed on the backlight module 75 in sequence. The manufacturing method of the liquid crystal panel 70G is similar to that in the seventh embodiment, and the fourth polarizer 79 can form on a surface of the fourth substrate 77 by means of printing mode. According to the eighth embodiment, a view position 40 (the actual position of the alternate opaque and clear linear sections is viewed by the viewer 45) of the parallax barrier 20G is the position of the third polarizer 78, a display pixel 50 of the liquid crystal panel 70G is located at the position of the fourth polarizer 79. As described above, the distance d in the eighth embodiment is much less than that in the prior art, and therefore the distance D is very short after calculating so as to be applied in specific field.

According to the seventh and eighth embodiments, at least one of the third substrate 76 and the fourth substrate 77 can also be replaced with a plastic substrate 60 by utilizing the technology of the plastic liquid crystal panel if necessary. The plastic substrate 60 can be made of one of Polyester (PES), Polyethylene Terephthalate (PET) and Artone. As described above, the distance d in the seventh and eighth embodiment is much less than that in the prior art, and therefore the distance D is very short after calculating so as to be applied in specific field.

The distance d is less than 0.8 mm as use the skill that is disclosed by the invention. The distance D is less than 60 cm so as to meet the requirements of display systems with medium/small dimensions.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A dual-mode display system for 2D and 3D viewing comprising:
a display device; and
a parallax barrier having a second polarizer, a second substrate, a liquid crystal layer, a first polarizer and a first substrate, characterized in that the second polarizer, the second substrate, the liquid crystal layer, the first polarizer and the first substrate are disposed on the display device in sequence.

2. The dual-mode display system for 2D and 3D viewing according to claim 1, wherein the display device has a display pixel and the distance between the first polarizer and the display pixel is less than 0.8 mm.

3. The dual-mode display system for 2D and 3D viewing according to claim 1, wherein the first polarizer is disposed on the first substrate by means of printing mode.

4. The dual-mode display system for 2D and 3D viewing according to claim 1, wherein the second substrate is replaced with a plastic substrate being less than 0.2 mm in thickness.

5. The dual-mode display system for 2D and 3D viewing according to claim 4, wherein the plastic substrate is made of Polyester (PES), Polyethylene Terephthalate (PET) and Artone, and the chemical formula of the Artone is as follows:

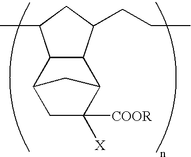

6. The dual-mode display system for 2D and 3D viewing according to claim 1, wherein the parallax barrier has an outside surface, the first polarizer is removed and disposed on the outside surface of the parallax barrier, and at least one of the first substrate and the second substrate is replaced with a plastic substrate.

7. The dual-mode display system for 2D and 3D viewing according to claim 6, wherein the plastic substrate is made of one of Polyester (PES), Polyethylene Terephthalate (PET) and Artone, and the chemical formula of the Artone is as follows:

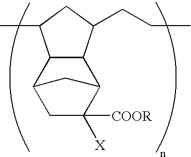

8. The dual-mode display system for 2D and 3D viewing according to claim 1, wherein the display device is a liquid crystal panel having a backlight module.

9. The dual-mode display system for 2D and 3D viewing according to claim 8, wherein the liquid crystal panel has a fourth polarizer and the function of the second polarizer is replaced with the function of the fourth polarizer of the liquid crystal panel, such that the second polarizer can be removed.

10. A dual-mode display system for 2D and 3D viewing comprising:
a back light module;
a parallax barrier having a first polarizer, a first substrate, a liquid crystal layer and a second substrate which are disposed on back light module in sequence; and
a liquid crystal panel having a third polarizer, a third substrate, a liquid crystal layer, a fourth substrate and a fourth polarizer, characterized in that the third polarizer, the third substrate, the liquid crystal layer, the fourth substrate and the fourth polarizer are disposed on the parallax barrier in sequence.

11. The dual-mode display system for 2D and 3D viewing according to claim 10, wherein the third polarizer is disposed on the third substrate by means of a printing mode.

12. The dual-mode display system for 2D and 3D viewing according to claim 10, wherein the liquid crystal panel having the third polarizer, the third substrate, the liquid crystal layer, the fourth polarizer and the fourth substrate, which are disposed on the parallax barrier in sequence.

13. The dual-mode display system for 2D and 3D viewing according to claim 12, wherein the fourth polarizer is disposed on the fourth substrate via printing.
